(19) United States
(12) Patent Application Publication
(10) Pub. No.: US 2013/0228595 A1
(43) Pub. Date: Sep. 5, 2013

(54) VALVE FOR DOSING VISCOUS FLUIDS, PARTICULARLY FOR DOSING PAINTS

(71) Applicant: ANTOINE CHASSAING, Clevilliers (FR)

(72) Inventor: ANTOINE CHASSAING, Clevilliers (FR)

(73) Assignee: FILLON TECHNOLOGIES, Faverolls (FR)

(21) Appl. No.: 13/756,846

(22) Filed: Feb. 1, 2013

Related U.S. Application Data
(63) Continuation of application No. 12/450,446, filed on Jan. 11, 2010, now abandoned.

(30) Foreign Application Priority Data
Mar. 28, 2007 (EP) 07290369.3

(51) Int. Cl. B67D 3/00

(52) U.S. Cl. CPC B67D 3/0041
USPC 222/504; 251/324

(57) ABSTRACT

The invention relates to a valve comprising a thimble (3), with an opening (3.1) at one end thereof and a plunger (4) arranged inside the thimble (3) and provided with a stopper (4.1) capable of stopping said opening (3.1). The ratio between the diameter (Do) of the passage surface (So) and the depth (P) of said opening is by far higher than 1, and the stopper is capable, in the stopping position, of coming flush with the outer surface (9) of the thimble in the vicinity of said opening.

The present invention relates to a valve for dosing viscous fluids, in particular for dosing paints. The valve according to the invention finds a particularly preferred application in the field of color dosing for automotive paints.

At present, in the field of automotive body repair, the color of a vehicle is obtained through mixing a number of base colors, commonly from five to ten bases. Such mixing is generally elaborated from a formulation, defined by the paint manufacturer, specifying the weight of each base to be incorporated for a defined total weight of mixing. The known dosing systems permit to reach an accuracy of 0.1 g, which is enough to prepare a total weight of mixing of at least 100 to 300 g, according to the color.

The technical solutions known by body repairers for dosing paints are based on the principle of a dosing cover adapted to a container, generally a rigid box, as described for example in WO 2006/027450 A2. The operator inclines the box equipped with its cover and operates an opening system to permit the paint to flow under gravity. By modulating the inclination and the opening degree, the operator controls the dosage to within one drop. Other known systems use semi-rigid or flexible containers. The operator then acts on the pressure he exerts to this container to make the paint exit thereof through an adapted orifice, and can control the drop.

One drawback of such systems is that the dosing accuracy is limited to the weight of the paint drop, namely about 0.03 to 0.1 g. On the other hand, at any moment, this drop may either fall into the mixing container and modify the weighting or stay stuck at the orifice and soil it. However, nowadays, the bases are more and more concentrated and covering and the surfaces to be repaired are more and more reduced, which creates a need to prepare small quantities of paint, of the order of 30 g to 50 g. To obtain the same colorimetric accuracy as obtained today with a dosing to within 0.1 g to prepare 100 to 300 g, a dosing accuracy as high as 0.01 g should be reached. Therefore, it is necessary to control a weight far lower than that of one drop. Another phenomenon specific to paints lies in the fact that the viscosities of the latter can vary in rather significant proportions. Indeed, the viscosity depends on many factors, of which notably the temperature of the fluid and, as far as paint is concerned, the loss of solvents. In particular, for the recent paints with a high solid-content and thus a low solvent-content, a low loss of solvents leads to a high increase of viscosity.

However, those viscosity variations highly interfere with the dosing accuracy, notably because of the turbulences generated during the paint jet expelling, inasmuch as viscosity is an important factor regarding the characterization of a turbulent flow.

GB 207 392 describes a valve for dosing liquids comprising a thimble with an opening at one end thereof and a plunger arranged inside the thimble, capable of stopping said opening. Such a valve is adapted for the dosing of hot liquids and liquids of corrosive nature. On the other hand, it is not very useful for dosing liquids having a certain viscosity and tending to dry rapidly, such as paints. Indeed, a viscous liquid passing through this valve will tend to significantly slow down at the elongated-tube-shaped lower opening of said valve. This slowing down is due to the viscosity of the liquid and thus to the substantial friction which will exert between the liquid and the walls of the valve's tubular opening. Thus, there will be a high chance that a part of the viscous liquid stays caught in the tubular opening and dries therein, thus plugging the valve and making it unusable.

EP 0 252 421 A1 describes another type of valve, comprising a thimble with an opening at one end thereof and provided with a plunger for stopping said opening. Such valve is designed for automatic beverage dispensers, thus for non-viscous liquids, which do not require a high dosing accuracy and which are not subjected to drying and abrasion.

On the other hand, EP 0 283 137 A1 describes a valve of the same type (with a thimble and a stopping plunger) adapted for the delivery of liquids such as paints. The plunger ends into a cone-against-cone plug (a mobile conical plug coming in rest against a conical seat formed around the thimble's opening) and, to avoid retention phenomena and facilitate the cleaning of the valve head, the distal-end face of the plunger comes flush with the opening in the stopping position. However, this valve has, because of its geometry, the drawback that it produces a turbulent flow in its open position, notably under the effect of the pressure of the ejected liquid; such turbulence is prejudicial to a satisfactory dosing and, further, generally leads to a drop remaining at the tip of the valve just after the closing thereof—which explains the need to provide an outer shape that is easy to clean after use.

DE 34 09 142 A1 describes a valve having a similar structure for delivering food liquids such as concentrated beverages, with the same drawbacks and limitations than those of the preceding document.

One object of the invention is to remedy the above-mentioned drawbacks, by providing a new valve structure specifically adapted for the very high accuracy dosing of viscous liquids such as paints.

The general object of the invention is to provide such a valve compensating for the difficulties specific to the liquid viscosity at the time of the forced expelling of this liquid through the valve.

More precisely, the invention aims to provide such a valve that intrinsically offers all the following advantages:
very high accuracy of dosing;
high reproducibility of the fluid quantities that are delivered;
lower sensitivity to viscosity variations of the fluid;
no catching of the paint at the valve's opening, so as to avoid any local retaining and risk of drying;
compatibility with a high-energy jet, notably in case of use with a pressurized container.

The lastly-mentioned aspect, i.e. controlling the paint jet, is particularly important when applied to dosing of colors for paints.

Actually, it is necessary to have a sufficient and well-controlled flow rate, which requires a pressurization of the container, and thus locally a higher flow-speed at the valve's opening.

On the other hand, it is important that the jet remains laminar; otherwise occurrence of turbulences will lead to formation of a drop staying at the tip of the valve, around the orifice, at the end of dosing.

Further, the matter is to be able to free from non-controllable phenomena having an influence on the fluid viscosity, such as temperature variations, loss of solvents, viscosity variations from one fabrication batch to one another or from one paint color to one another.

The above-mentioned objects are achieved according to the invention by a dosing valve of the type disclosed in the above-mentioned EP 0 283 137 A1, i.e. comprising a thimble with an opening at one end thereof and a plunger arranged inside the thimble and provided with a stopper capable of stopping said opening, the stopper being capable, in the stopping position, of coming flush with the outer surface of the thimble in the vicinity of said opening.

Said valve is characterized, according to the invention, in that the ratio between the diameter of the passage surface and the depth of said opening is far higher than 1.

As used herein, “surface passage” means the surface So of the opening in the transverse direction with respect to the fluid flowing direction. This passage surface may be circular and offers a diameter Do. This diameter Do is a length that could also be qualified as diameter of the opening. The “depth” of the opening is a dimension which could also be called “thickness” of the opening. It is the length of the opening in the fluid flowing direction. Accordingly, the depth of the opening is perpendicular to the passage surface of the latter.

Thus, the opening is designed so as to offer the shortest length possible for guiding the fluid jet passing through the valve: the opening is formed in a low-thickness area and the length of the contact area between the opening and the jet is small with respect to the surface of the opening.

In particular, inasmuch as the opening is designed so as to have the shortest jet-guiding length possible in the vicinity of the orifice (the opening being formed in a low-thickness area), the length of the contact area between the opening and the fluid jet will be reduced, allowing a perfectly laminar flow to be kept despite the high kinetic energy of the jet expulsion.

Thus the fluid flow-rate depends only on the characteristics inherent to the valve geometry, the pressure applied to the fluid and the density of the latter, and that in a manner virtually independent of the fluid viscosity. Therefore, an extremely accurate and perfectly reproducible dosing can be obtained.

Further, the particular configuration of the valve according to the invention favors a sharp cut-off of the fluid jet, with no smudge and no formation of drop at the opening. The suppression or the great size-reduction of the drop permits to significantly increase the dosing accuracy, while freeing from the dispersion due to the drop and greatly reducing the valve soiling.

Let Do be the diameter of the passage surface and P the depth, the above-mentioned condition may be written as follows:

Do/P>>1 (Equation 1)

The condition “far greater than 1” means that said ratio is greater than or equal to 3. This ratio is preferably greater than or equal to 5, which may be written as follows:

Do/P≧5 (Equation 2)

With an opening having such an above-described ratio, the valve's passage is very abruptly reduced over a very short length, according to the diaphragm principle. The thimble area comprising said opening may thus be qualified as a “diaphragm”. The fluid flow is vented to atmosphere immediately at the exit of this diaphragm. At the throttling of this diaphragm, the fluid is highly accelerated over a very short length.

According to the Bernoulli law, this acceleration corresponds to the very fast transformation of a pressure potential energy into a kinetic energy, without any effect of the viscosity. The diaphragm has a very short length, so as to limit the head losses downstream from the throttling and to avoid the turbulence phenomena described by Reynolds, despite the high speed of the fluid.

A laminar jet of fluid is thus obtained, the flow rate of which depends only on the diaphragm characteristics, the pressure applied to the fluid at the entrance of the valve, and the density of the fluid. The fluid viscosity hardly intervenes. This phenomenon is important for the dosing control because, if the diaphragm characteristics, the pressure applied and the density of the fluid are steady and easy to control, the fluid viscosity depends on many factors, of which notably the temperature of the fluid and, as far as paint is concerned, the loss of solvents. For the recent paints with a high solid-content and thus a low solvent-content, a low loss of solvents leads to a high increase of viscosity.

Another advantage of the laminar jet is due to the fact that, at the exit of the diaphragm, the fluid has a high speed, and thus a great kinetic energy. By associating to the diaphragm a stopping system, namely the plunger, arranged upstream from the diaphragm and stopping the fluid flow-rate directly at the diaphragm throttling, namely said opening of the thimble, and by abruptly closing the opening by means of the plunger, a very sharp cut off of the jet is obtained.

Such jet cut off is located in an area in which the fluid has a high speed, and thus the fluid flow-rate upstream from the opening is abruptly arrested. As for the fluid immediately downstream from the stopping area, it has a great kinetic energy and continues its travel. It is this kinetic energy that permits the fluid to free from the forces of adherence with the diaphragm and plunger surfaces, and thus to avoid the formation of a drop. The suppression or the great size-reduction of this drop permits to significantly increase the dosing accuracy, freeing from the dispersion due to the drop, while greatly reducing the valve soiling.

When closed, the stopper comes flush with the outer surface of the thimble in the vicinity of the opening and is thus capable of fully closing the latter with no retention area, which favors a sharp cut off of the fluid jet, with no smudge and no formation of drop at the opening. Preferably, the stopping surface of the stopper is in the shape of a point, a plane or a frustum of a sphere.

As used herein, “frustum of a sphere” means a part of a sphere. A frustum of a sphere can also be defined as a cut or truncated sphere, to which a part is missing. Therefore, a “frustum of a sphere” is a part of a sphere in the same way as a frustum of a cone is a part of a cone. In a preferred embodiment, the thimble has, seen from the outside, a convex or plane area in the vicinity of said opening.

Such a plane, or else outwardly bulged or arched, area has no external recess or concavity which could serve as a fluid retention area. The formation of smudges or drops is thus inhibited.

In a particularly advantageous manner, the shape of the convex area may correspond to a semi-sphere.

Moreover, in the case of a convex area, said opening may be located at the apex of the convex area. In the case of a plane area, said opening may be located at the center of the plan area.

Preferably, the plunger is made of a magnetic material. In this case, the valve may further comprise a yoke made of a magnetic material, the yoke and the plunger being made in such a way that the presence of a magnetic field is capable of creating an attractive force between the yoke and the plunger. By activating a magnetic field, the plunger can then be attracted toward the yoke so as to clear said opening. Advantageously, during an attraction phase, the plunger is in a position of abutment against the yoke.

Further, the ratio of the thimble's passage surface to the passage surface of said opening is preferably far greater than 1.

Let Sd be the thimble's passage surface and So the opening's passage surface, this relation is written as follows:

Sd/So>>1 (Equation 3)

The condition “far greater than 1” means that said ratio is greater than or equal to 9 (3×3). This ratio is preferably greater than or equal to 50, which may be written as follows:

Sd/So≧50 (Equation 4)

The thimble's passage surface is defined as the maximum extent of the chamber defined by the thimble in the transverse direction with respect to the fluid flowing direction.

With such a ratio between the two passage surfaces, the duct upstream from the stopping area of the valve offers a relatively large passage. This permits to maximally limit the effects of the fluid viscosity on the flowing speed. Thus, the head losses upstream from the diaphragm are very low because the passage section is large, and thus the fluid speed is low. The fluid circulation through the valve and up to the thimble's opening is facilitated by a large passage section with respect to the opening. The matter is, on the one hand, to limit the head losses depending on the viscosity, but also to avoid any turbulent state upstream from the stopping area.

In other words, when said ratio is respected, a very abrupt reduction of the fluid passage section is imposed. The area upstream from the opening is relatively wide and flared, and the opening offers a very neat throttling, as the diaphragms used as flow-rate controllers in hydraulics.

In a preferred embodiment, the dosing valve further comprises a spring adapted to push the plunger into the stopping position. Preferably, said spring is arranged at least in part inside said plunger.

Advantageously, the plunger may comprise at least one opening allowing the fluid to pass from an arrival area of the thimble to said opening of the thimble.

Preferably, the dosing valve further comprises a means capable of moving said plunger between a position of stopping and a position of clearing said opening. In a preferred embodiment, this means comprises an electric coil covering the thimble.

To limit the effects of a transient state during which the flow is non laminar, it is preferable that the valve opening and closing operations are the most rapid possible.

Moreover, if the valve is driven in an “all or nothing” mode, the control thereof may be easily automated.

The invention also relates to a fluid container with a valve comprising at least in part the above-described characteristics.

In such a container, the fluid displacement may be produced through pressurization of the fluid. With such a fluid displacement through pressure, the drawbacks of a gravity system, such as that described in WO 2006/027450 A2, which strongly depends on the filling level of the container, no longer exist. Pressurizing the fluid permits to free from the influence of level variations of the container. Indeed, it is easy to apply a pressure that is great enough to make insignificant the effect of the filling level of the container. In this case, the relative pressure between the fluid in the arrival area of the thimble and the outside of the valve is preferably steady.

An embodiment of the valve according to the invention will now be described with reference to the appended drawings.

FIG. 1 shows an embodiment of the valve according to the invention, in a longitudinal cross-sectional view and in a closed position;

FIG. 2 shows the plunger of the valve of FIG. 1, in a front view;

FIG. 3 shows the valve of FIG. 1 in an open position during the flowing of a fluid through the valve;

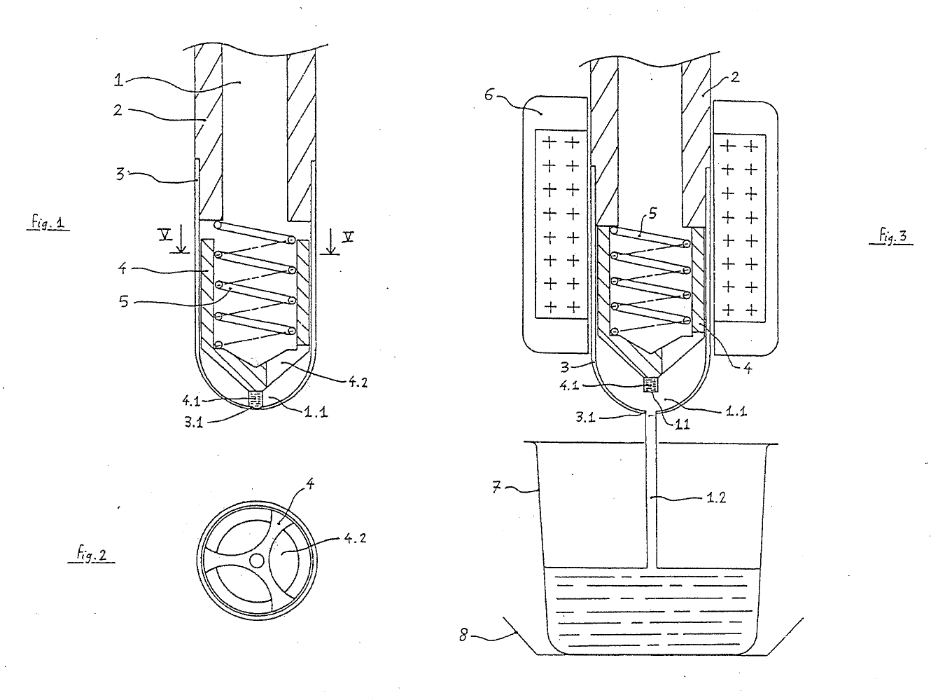

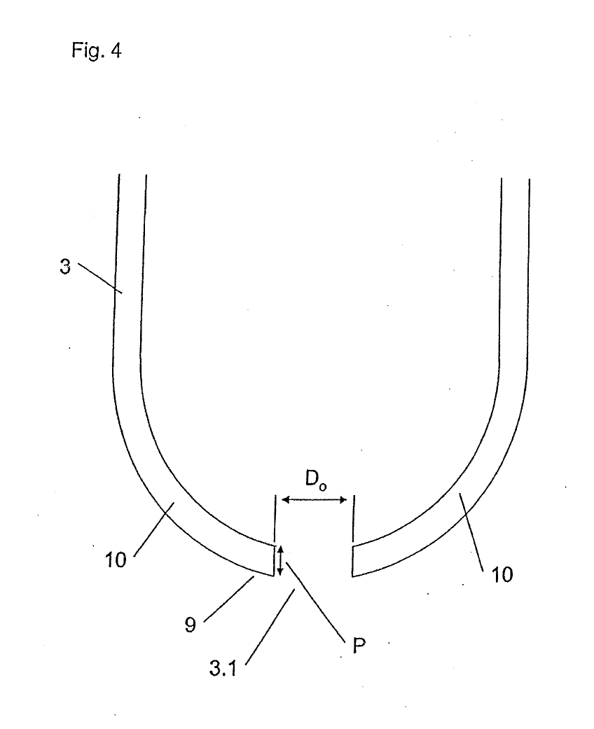

FIG. 4 is a detail view of the lower part of the thimble of the valve of FIG. 1; and

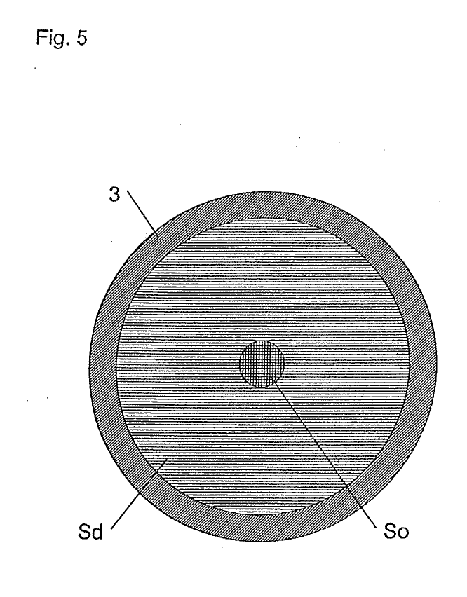

FIG. 5 is a cross-sectional view following the line V-V of FIG. 1.

FIG. 1 shows an embodiment of a valve according to the invention. In FIG. 1, the valve is shown without its electromagnetic control system, in a closed position.

The valve is made up of a yoke 2 connected to a fluid container (not shown). This yoke is made of a magnetic-flow permeable material. A thimble 3 is fastened to the yoke 2. It is made of a non-magnetic material. It comprises at its end an opening 3.1. Guided inside the thimble is a plunger 4 made of a magnetic-flux permeable material. The plunger 4 comprises a stopper 4.1 capable of closing the opening 3.1 of the thimble 3. This stopper 4.1 may be an elastomeric added-part, and the stopping surface 11 (cf. FIG. 3) may be in the shape of a point, a plane or a frustum of a sphere. The plunger is kept in the low position through the action of a spring 5.

The fluid is brought in the arrival area 1 under a certain relative pressure, which may be generated by any means, merely by the effect of gravity, or by vacuuming the outside environment of the valve. The fluid circulates in the body of the valve, inside and around the plunger 4 and the spring 5. The fluid easily circulates up to the stopping area 1.1 through the wide openings 4.2 made in the plunger 4.

FIG. 2 shows a view of the plunger 4 and highlights the openings 4.2 permitting the fluid to circulate from the arrival area 1 to the stopping area 1.1.

FIG. 3 shows the valve in the work configuration and open position. It is covered with a cylindrical coil 6 capable of inducing a magnetic field in the yoke 2 and the plunger 4, through the thimble 3. This magnetic field creates an attractive force between the yoke 2 and the plunger 4. When this force exceeds the strength of the spring 5, the plunger 4 lifts with the stopper 4.1, which clears the opening 3.1 of the thimble 3. The fluid may then exit from the valve into a laminar jet 1.2, so as to be picked up in a vessel 7, laid on the plate 8 of a balance.

FIG. 4 shows in detail the lower part of the thimble 3. The diameter Do of the passage surface So of the opening 3.1, the depth P of the opening 3.1, the convex area 10 of the thimble 3, as well as the outer surfce 9 of the thimble 3 in the vicinity of the opening 3.1, are well distinguishable in the figure.

FIG. 5 is a cross-sectional view following the line V-V of FIG. 1. In this cross-sectional view, the spring 5 and the plunger 4 have been omitted, so as to represent more clearly the passage surface Sd of the thimble 3 and the passage surface So of the opening 3.1. It clearly appears that So is far smaller than Sd. In FIG. 5, it is to be noticed that Sd corresponds to the totality of the surface limited by the thimble's walls, including in particular the surface So. Accordingly, So may be considered as a central part of Sd.

Thanks to the valve according to the invention, a dosing system is obtained which finds a particularly advantageous application in dosing base colors for automotive repairing. Such dosing system is economically adapted for the average body repairer, very accurate, easy to use, while requiring a minimum cleaning.

Of course, the use of the valve according to the invention is not limited to the field of automotive paints. Indeed, said valve may be used in any application needing an accurate and reliable fluid dosing.

1. A valve for dosing viscous fluids, comprising:
a thimble (3) with an opening (3.1) at one end thereof, and
a plunger (4) arranged inside the thimble (3) and provided with a stopper (4.1) capable of stopping said opening (3.1), said stopper being capable, in the stopping position, of coming flush with the outer surface (9) of the thimble in the vicinity of said opening,
characterized in that the ratio between the diameter (Do) of the passage surface (So) and the depth (P) of said opening is far higher than 1.

2. The dosing valve according to claim 1, wherein the stopping surface (11) of the stopper is in the shape of a point, a plane or a frustum of a sphere.

3. The dosing valve according to claim 1, wherein the thimble, seen from the outside, has a convex or plane area (10) in the vicinity of said opening (3.1).

4. The dosing valve according to claim 3, comprising a convex area whose shape corresponds to a semi-sphere.

5. The dosing valve according to claim 3, wherein said opening is located at the apex of the convex area in the case of a convex area, and at the center of the plane area in the case of a plane area.

6. The dosing valve according to claim 1, wherein the plunger is at least in part made of a magnetic or magnetic-flow permeable material.

7. The dosing valve according to claim 6, wherein the valve further comprises a yoke (2) made of a magnetic material, the yoke and the plunger being made in such a way that the presence of a magnetic field is capable of creating an attractive force between the yoke and the plunger.

8. The dosing valve according to claim 1, wherein the ratio between the passage surface (Sd) of the thimble and the passage surface (So) of said opening is far greater than 1.

9. The dosing valve according to claim 1, further comprising a spring (5) capable of pushing the plunger to a stopping position.

10. The dosing valve according to claim 9, wherein said spring is arranged at least in part inside said plunger.

11. The dosing valve according to claim 1, wherein the plunger comprises at least one opening (4.2) permitting the fluid to pass from an arrival area (1) of the thimble to said opening of the thimble.

12. The dosing valve according to claim 1, further comprising a means (6) capable of moving said plunger between a position of stopping and a position of clearing said opening.

13. The dosing valve according to claim 12, wherein said means comprises an electric coil (6) covering the thimble.

14. Fluid container, comprising a valve according to claim 1.
